(19) United States
(12) Patent Application Publication
(10) Pub. No.: US 2019/0017481 A1
(43) Pub. Date: Jan. 17, 2019

(54) Fuel Injection System For An Internal Combustion Engine

(71) Applicant: Continental Automotive GmbH, Hannover (DE)

(72) Inventor: Max Scheller, Stamsried (DE)

(73) Assignee: Continental Automotive GmbH, Hannover (DE)

(21) Appl. No.: 16/033,095

(22) Filed: Jul. 11, 2018

(30) Foreign Application Priority Data
Jul. 13, 2017 (DE) 10 2017 211 981.0

(51) Int. Cl. F02M 59/46; F02M 59/10; F02M 63/02; F02M 63/00

(52) U.S. Cl. CPC F02M 59/462; F02M 59/102; F02M 2200/50; F02M 63/005; F02M 63/0265

(57) ABSTRACT

The present disclosure relates to internal combustion engines. Various embodiments may include a fuel injection system for an internal combustion engine comprising: a high-pressure fuel pump with a pressure chamber and a pump piston; a high-pressure region downstream of the pump piston; and a valve arrangement connecting the pressure chamber to the high-pressure region. The valve arrangement includes an outlet valve and a pressure-limiting valve. The outlet valve and the pressure-limiting valve are mounted in two separate receptacle bores in a common valve housing. The receptacle bores extend along a longitudinal axis of the valve housing. The valve housing defines a central flow bore. The receptacle bores are each fluidly connected to the central flow bore by a bore intersection.

### CROSS-REFERENCE TO RELATED APPLICATIONS

This application claims priority to DE Application No. 10 2017 211 981.0 filed Jul. 13, 2017, the contents of which are hereby incorporated by reference in their entirety.

### TECHNICAL FIELD

The present disclosure relates to internal combustion engines. Various embodiments may include a fuel injection system for an internal combustion engine.

### BACKGROUND

In common-rail fuel injection systems, the generation of pressure in a fuel to be burned in an internal combustion engine and the injection of the fuel into combustion chambers of the internal combustion engine are decoupled from one another. Here, a high-pressure fuel pump compresses the fuel fed to it from a low-pressure region, for example from a tank. At the outlet side of the high-pressure fuel pump, a volume flow of the compressed fuel then flows to a high-pressure region, for example to a high-pressure storage line, the common rail, from where the compressed fuel is injected into the combustion chambers of the internal combustion engine.

In such systems, the high-pressure fuel pump generates, for example, a pressure in a range from 150 bar to 400 bar when the fuel is gasoline, and a pressure in a range from 1500 bar to 3000 bar when the fuel is diesel. The respective fuel is present at this generated high pressure in the high-pressure region and is fed, for example, from the high-pressure storage line to the combustion chambers of the internal combustion engine via injection valves.

To ensure the correct functioning of the fuel injection system, and to be able to satisfy possible special demands, a fuel injection system generally has at least two valves, specifically an outlet valve and a pressure-limiting valve. During an upward movement of a pump piston, if the high-pressure fuel pump is designed as a piston pump, the outlet valve which functions as high pressure valve opens, and the fuel can be delivered into the high-pressure region. During the downward movement of the pump piston, the outlet valve closes, such that a return flow of the compressed fuel from the high-pressure region back into the pressure chamber is prevented. The pressure-limiting valve prevents an excessive pressure increase in the high-pressure region, in particular in the high-pressure storage line. If the pressure in the high-pressure region exceeds a threshold value, a certain volume flow of the fuel is discharged either into the pressure chamber or into the low-pressure region via the pressure-limiting valve.

In known applications, each of the above-mentioned valves—outlet valve and pressure-limiting valve—is installed, for example, separately in a housing of the high-pressure fuel pump. As a result, a very large installation space is necessary, as result of which the efficiency level of the high-pressure fuel pump drops, and a connection to the high-pressure fuel pump under a relatively high system pressure becomes difficult, and even no longer possible to implement. Alternatively, it is, for example, also known to provide the pressure-limiting valve and the outlet valve in series with one another, but this gives rise to inconstant conduction of the fuel as a fluid by means of multiple changes of direction, and can also give rise to an undesired drop in pressure and a reduction in the fatigue strength as result of cavitation and erosion. Furthermore, this gives rise to complicated, and therefore to very uneconomic and expensive components, in particular with respect to the valve seats which are to be required.

### SUMMARY

The teachings of the present disclosure may include an improved fuel injection system having a corresponding valve arrangement. For example, some embodiments include a fuel injection system (10) for an internal combustion engine having: a high-pressure fuel pump (18) with a pressure chamber (30) in which a pump piston moves during operation for the purpose of highly pressurizing a fuel (12); a high-pressure region (25) which is arranged downstream of the high-pressure fuel pump (18) and into which the high-pressure fuel pump (18) feeds the highly-pressurized fuel (12); and a valve arrangement (22) for connecting the pressure chamber (30) to the high-pressure region (25), wherein the valve arrangement (22) has an outlet valve (24), with an outlet valve closing element (42) which is preloaded against an outlet valve seat (46) counter to a pressure force acting from the pressure chamber (30), and a pressure-limiting valve (38), with a pressure-limiting valve closing element (48) which is preloaded against a pressure-limiting valve seat (50) counter to a pressure force acting from the high-pressure region (25). In some embodiments, the outlet valve (24) and the pressure-limiting valve (38) are each accommodated in a separate receptacle bore (40) in a common valve housing (36), which receptacle bores (40) extend essentially along a longitudinal axis (52) of the valve housing from a junction surface (54), arranged at a first longitudinal end (56) of the valve housing (36), into the valve housing (36). In some embodiments, the valve housing (36) has a central flow bore (62) at a second longitudinal end (60) arranged opposite the first longitudinal end (56). In some embodiments, the receptacle bores (40) are each fluidly connected to the flow bore (62) by means of a bore intersection (64).

In some embodiments, the receptacle bores (40) are embodied as blind hole bores (58), and extend, in particular, parallel to one another and parallel to the longitudinal axis (52) of the valve housing.

In some embodiments, the receptacle bores (40) have a first bore region (76) with a first bore diameter (78), and a second bore region (80) with a second bore diameter (82), wherein the second bore diameter (82) is smaller than the first bore diameter (78), wherein in each case the second bore region (80) forms a blind hole end (88), wherein the receptacle bores (40) are embodied, in particular, in a geometrically identical fashion.

In some embodiments, the flow bore (62) is embodied symmetrically about the longitudinal axis (52) of the valve housing (36), wherein the receptacle bores (40) are arranged, in particular, symmetrically about the longitudinal axis (52) of the valve housing.

In some embodiments, the valve housing (36) is formed by means of a high-pressure port (34) for connecting a high-pressure storage line (26) to a housing of the high-pressure fuel pump (18).

In some embodiments, the high-pressure port (34) has a first attachment region (90) for attaching the high-pressure port (34) to the housing of the high-pressure fuel pump (18) in a high-pressure-tight fashion, and a second attachment region (92) for connecting the high-pressure storage line (26) to the high-pressure port (34), wherein the first attachment region (90) is formed at the first longitudinal end (56) of the valve housing (36), and the second attachment region (92) is formed at the second longitudinal end (60) of the valve housing (36).

In some embodiments, the high-pressure port (34) has, along the longitudinal axis (52) of the valve housing, a first high-pressure connection region (66) with a first connection diameter (70), and a second high-pressure connection region (68) with a second connection diameter (72), wherein the second connection diameter (72) is smaller than the first connection diameter (70), wherein the receptacle bores (40) are arranged exclusively in the first high-pressure connection region (66).

In some embodiments, the flow bore (62) is arranged in the second high-pressure connection region (68) and extends from the second high-pressure connection region (68) into the first high-pressure connection region (66).

### BRIEF DESCRIPTION OF THE DRAWINGS

An example embodiment of the teachings herein is explained in more detail in the following text on the basis of the accompanying drawings. In the figures:

FIG. 1 shows a schematic overview illustration of a fuel injection system with a high-pressure fuel pump and a high-pressure storage line between which a valve arrangement is arranged, in accordance with the teachings of the present disclosure;

FIG. 2 shows a longitudinal sectional illustration of the valve arrangement from FIG. 1; and

FIG. 3 shows a plan view of the valve arrangement in FIG. 2 from above.

### DETAILED DESCRIPTION

In some embodiments, a fuel injection system for an internal combustion engine includes a high-pressure fuel pump with a pressure chamber in which a pump piston moves during operation for highly pressurizing a fuel, and a high-pressure region which is arranged downstream of the high-pressure fuel pump and into which the high-pressure fuel pump feeds the highly-pressurized fuel.

In some embodiments, the fuel injection system comprises a valve arrangement for connecting the pressure chamber to the high-pressure region, wherein the valve arrangement has an outlet valve, with an outlet valve closing element which is preloaded against an outlet valve seat counter to a pressure force acting from the pressure chamber, and a pressure-limiting valve with a pressure-limiting valve closing element which is preloaded against a pressure-limiting valve seat counter to a pressure force acting from the high-pressure region. The outlet valve and the pressure-limiting valve are each accommodated in a separate receptacle bore in a common valve housing, which receptacle bores extend essentially along a longitudinal axis of the valve housing from a junction surface, arranged at a first longitudinal end of the valve housing, into the valve housing. The valve housing has a central flow bore at a second longitudinal end arranged opposite the first longitudinal end. The receptacle bores are each fluidly connected to the flow bore by means of a bore intersection.

A bore intersection is to be understood here as being an undercut with which the individual receptacle bores for the valves are connected to the flow bore. The receptacle bores are therefore not arranged flush with the flow bore but rather are offset with respect to the flow bore, relative to the longitudinal axis of the valve housing, such that they project only partially into the flow bore at their end. The flow bore therefore cuts into a partial region of the respective receptacle bore. As a result of this particular arrangement of the flow bore and of the receptacle bores it is possible to arrange the two valves of the valve arrangement essentially parallel and next to one another in the valve housing, and nevertheless achieve a saving in installation space for the entire valve arrangement. As a result, the entire assembly can be configured to be as small as possible, and the hydraulic disadvantages which a geometric series connection can entail can be avoided.

In some embodiments, the flow bore conducts high pressure, that is to say it is arranged on the outflow side with respect to the outlet valve and leads to the high-pressure region arranged downstream of the high-pressure fuel pump. In contrast, the junction surface may be arranged in such a way that when the high-pressure fuel pump is in a pump stroke a high pressure is also present but if the high-pressure fuel pump is in the suction stroke, a low pressure can also be present at the junction surface.

The receptacle bores may comprise blind hole bores and extend, in particular, parallel to one another and parallel to the longitudinal axis of the valve housing. By means of such an arrangement in which all the bores run essentially parallel to one another in the valve housing, there can be saving in installation space.

In some embodiments, the receptacle bores may have a first bore region with a first bore diameter, and a second bore region with a second bore diameter, wherein the second bore diameter is smaller than the first bore diameter, wherein in each case the second bore region forms a blind hole end. This means that the receptacle bores extend essentially from the junction surface with a relatively large bore diameter into the valve housing, in order to taper to one end of the blind hole. This makes it possible to form shoulders in the receptacle bores, on which shoulders, for example, elements of the respective valve are supported, these being for example a restoring spring or a closing element. The tapering has as a result that the bore intersections of the receptacle bores with the flow bore can each be kept relatively small, such that the valve housing maintains a certain basic stability overall.

In some embodiments, the receptacle bores are geometrically identical. This may be advantageous for the manufacturing process, since in this way only identical bores have to be easily generated in the valve housing. The term “identical” is to be understood as meaning with respect to the receptacle bores that in such an identical embodiment they have the same length along the longitudinal valve axis and also the same bore diameter.

Furthermore, they may have the same shape, specifically, in particular, the shape of a blind hole bore. When there are two identical receptacle bores, these two receptacle bores may start from the same surface, specifically the junction surface which extends perpendicularly with respect to the longitudinal axis of the valve housing. The two receptacle bores may also end at the same height perpendicularly with respect to the longitudinal axis of the valve housing.

In some embodiments, the flow bore extends symmetrically about the longitudinal axis of the valve housing. In this case, the receptacle bores may be arranged symmetrically about the longitudinal axis of the valve housing. A symmetrical arrangement or arrangement of the corresponding bores in the valve housing ensures, on the one hand, that there is increased stability of the valve housing and, the other hand, that the available installation space in the valve housing is utilized particularly well.

In some embodiments, the valve housing is formed by means of a high-pressure port for connecting a high-pressure storage line to a housing of the high-pressure fuel pump. A high-pressure port which passes on the highly-pressurized fuel from the high-pressure fuel pump to elements arranged downstream of the high-pressure fuel pump is usually provided in any case on a housing of the high-pressure fuel pump.

The high-pressure port may include a first attachment region for attaching the high-pressure port to the housing of the high-pressure fuel pump in a high-pressure-tight fashion, and a second attachment region for connecting the high-pressure storage line to the high-pressure port, wherein the first attachment region is formed at the first longitudinal end of the valve housing, and the second attachment region is formed at the second longitudinal end of the valve housing. The high-pressure storage line may comprise a common-rail, from which usually a plurality of injectors extend, which inject the highly-pressurized fuel into combustion chambers of an internal combustion engine. The first attachment region with which the high-pressure port is connected to the housing of the high-pressure fuel pump therefore forms the junction surface of the valve housing, from which the receptacle bores extend into the valve housing. The second attachment region, to which the high-pressure storage line is connected, therefore forms the region of the valve housing in which the flow bore is arranged. The second attachment region therefore may include an external thread via which the high-pressure storage line can be attached to the high-pressure port by means of a screw connection.

In some embodiments, the high-pressure port can be attached to a housing of the high-pressure fuel pump, for example by means of a welded connection. However, it is also conceivable to attach the high-pressure port via a screw connection to a corresponding anti-twist protection on the housing of the high-pressure fuel pump.

The individual parts of the two valves, for example a sleeve which forms a valve seat, closing elements which close the valve together with the valve seat, restoring springs which prestress the closing elements against the valve seat, and sleeves on which a restoring spring can be supported, are preferably provided as individual parts which are introduced individually into the respective receptacle bore and attached therein. This can be done, for example, by press-fit and/or crimp-fit assemblies. As a result, the high-pressure port can be equipped as a valve housing with the individual parts of the two valves and therefore be made available in its entirety as what is referred to as a cartridge structure which can be checked outside the housing of the high-pressure fuel pump and then attached to the high-pressure fuel pump as a composite component.

In some embodiments, the high-pressure port may include, along the longitudinal axis of the valve housing, a first high-pressure connection region with a first connection diameter and a second high-pressure connection region with a second connection diameter, wherein the second connection diameter is smaller than the first connection diameter. The receptacle bores are arranged here exclusively in the first high-pressure connection region. Accordingly, the high-pressure port may have a stepped design with a relatively large connection diameter in which the receptacle bores are provided. As a result, in the first high-pressure connection region installation space can be correspondingly made available for accommodating the two valves. The flow bore may be arranged in the second high-pressure connection region and extend from the second high-pressure connection region into the first high-pressure connection region.

The relatively large connection diameter of the high-pressure port is accordingly provided only where the receptacle bores are located. Starting from the point from which the installation space is no longer required for the receptacle bores, the high-pressure port may taper, specifically in the region of the flow bore, where the high-pressure port connects to the high-pressure storage line. As a result, installation space can be made available for connecting the high-pressure storage line. Correspondingly, the flow bore which intersects with the two receptacle bores extends into the first high-pressure connection region in order to thereby permit a fluidic connection between the receptacle bores and the flow bore in the region in which the largest possible installation space is available, specifically in the first high-pressure connection region.

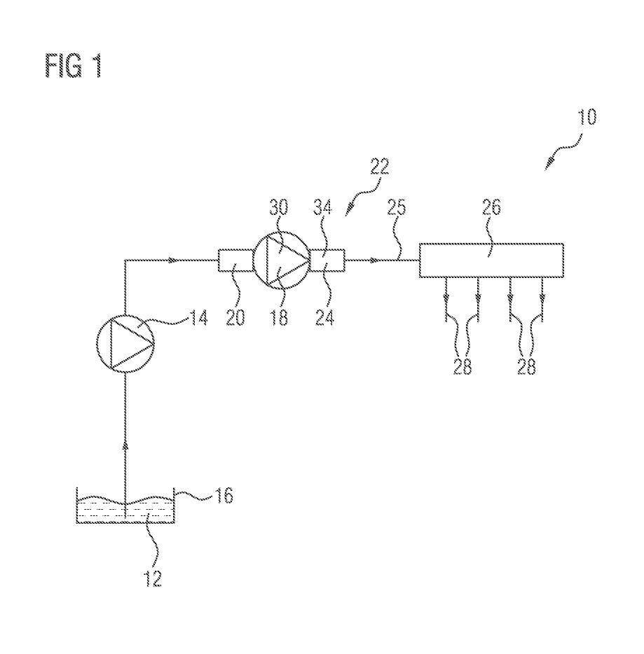

FIG. 1 shows a schematic overview illustration of a fuel injection system 10, in which a fuel 12 is delivered by a pre-delivery pump 14 from a tank 16 to a high-pressure fuel pump 18. The fuel 12 is highly pressurized in the high-pressure fuel pump 18, wherein the quantity of fuel 12 that is pressurized in the high-pressure fuel pump 18 can be set through corresponding active actuation of an inlet valve 20. Via a valve arrangement 22 comprising an outlet valve 24, the pressurized fuel 12 is then fed to a high-pressure region 25, in particular a high-pressure storage line 26, on which injectors 28 are arranged via which the pressurized and stored fuel 12 can be injected into combustion chambers of an internal combustion engine.

The high-pressure fuel pump 18 may include a piston pump and therefore has a pump piston which moves up and down in a translatory fashion in a pressure chamber 30 during operation, and by means of this movement compresses and therefore pressurizes the fuel 12 located in the pressure chamber 30. The pressurized fuel 12 then passes from the pressure chamber 30 into the high-pressure storage line 26 via the outlet valve 24. To connect the high-pressure storage line 26 to the pressure chamber 30, which may be arranged in a housing of the high-pressure fuel pump 18, the system may include a high-pressure port 34.

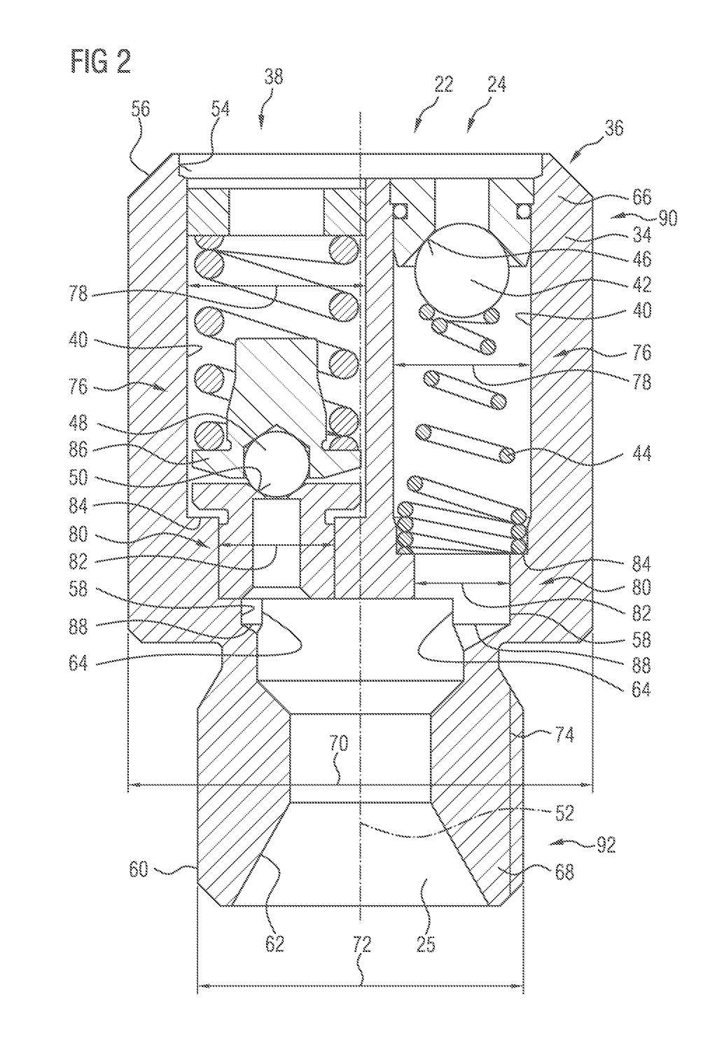

To provide a desired pressure in the fuel 12 which is situated in the high-pressure storage line 26, the valve arrangement 22 is provided and, in the present embodiment said valve arrangement 22 may be arranged in the high-pressure port 34. The high-pressure port 34 performs here the function of a valve housing 36 for the valve arrangement 22. The high-pressure port 34 which is provided as a valve housing 36 is shown in greater detail in a longitudinal sectional illustration in FIG. 2.

The valve arrangement 22 has the outlet valve 24. This outlet valve 24 ensures that only fuel 12 at the desired pressure exits the pressure chamber 30 in the direction of the high-pressure storage line 26. Furthermore, said outlet valve 24 prevents a backflow of the compressed fuel 12 back into the pressure chamber 30 when a negative pressure prevails there owing to a downward movement of the pump piston of the high-pressure fuel pump 18. The valve arrangement 22 furthermore comprises a pressure-limiting valve 38. Said pressure-limiting valve 38 prevents an excessive pressure increase in the high-pressure storage line 26, because if the pressure in the high-pressure storage line 26 exceeds a particular value, a certain volume flow of the fuel 12 is discharged back into the pressure chamber 30 via the pressure-limiting valve 38.

The high-pressure port 34 forms a common valve housing for the outlet valve 24 and the pressure-limiting valve 38. For this purpose, in each case a receptacle bore 40 is provided, wherein in each case one of the two valves 24, 38 is arranged on one of the two receptacle bores 40. In the present embodiment, both valves 24, 38 are formed as passive valves and are connected in anti-parallel with respect to one another. The outlet valve 24 therefore has an outlet valve closing element 42 which is preloaded by a restoring spring 44 against an outlet valve seat 46 counter to a pressing force acting from the pressure chamber 30. Said outlet valve 24 accordingly opens if the pressing force from the pressure chamber 30 overcomes the spring force of the restoring spring 44, such that fuel 12 can flow through the receptacle bore 40 and out of the high-pressure port 34.

In the pressure-limiting valve 38 is a pressure-limiting valve closing element 48 which is preloaded by a restoring spring 44 against a pressure-limiting valve seat 50 counter to a pressing force acting from the high-pressure region 25. The pressure-limiting valve 38 therefore does not open until the pressing force from the high-pressure region 25 becomes greater than the spring force of the restoring spring 44.

The receptacle bores 40 are arranged parallel to one another and parallel to a longitudinal axis 52 of the valve housing of the valve housing 36. The receptacle bores 40 extend from a junction surface 54 at a first longitudinal end 56 of the valve housing 36 into the valve housing 36. Both receptacle bores 46 are configured here as blind hole bores 58.

A flow bore 62, which is formed centrally, in particular symmetrically about the longitudinal axis 52 of the valve housing, extends into the valve housing 36 from a second longitudinal end 60, arranged opposite the first longitudinal end 56, of the valve housing 36. The two receptacle bores 40 are fluidly connected to this flow bore 62 via a bore intersection 64.

The outlet valve 24 and the pressure-limiting valve 38 are usually configured in such a way that both require similar installation spaces and can therefore be arranged parallel to one another in the high-pressure port 34, to reduce the processing and size of the housing of the high-pressure fuel pump 18. Both valves 24, 38 are connected to one another, via the flow bore 62 in the high-pressure port 34 via the undercut, that is to say the bore intersection 64, and to the high-pressure region 25. The two valves 24, 38 are therefore arranged parallel to one another, but connected in anti-parallel with respect to one another.

As a result, installation space for the passive valves 24, 38 can be eliminated in the housing of the high-pressure fuel pump 18 where they are normally arranged. Furthermore, in this way an external assembly 18 is produced as a so-called cartridge which is constructed parallel to the high-pressure fuel pump 18 and can also be tested outside the high-pressure fuel pump 18.

The high-pressure port 34 has, along the longitudinal axis 52 of the valve housing, a first high-pressure connection region 66 and a second high-pressure connection region 68. The first high-pressure connection region 66 has a first connection diameter 70, and the second high-pressure connection region 68 has a second connection diameter 72. The first connection diameter 70 is constructed to be larger than the second connection diameter 72. This is because the receptacle bores 40 for the two valves 24, 38 are arranged in the first high-pressure connection region 66 with the relatively large connection diameter 70. Only the flow bore 62 is arranged in the second high-pressure connection region 68. The first high-pressure connection region 66 therefore makes available sufficient installation space for the accommodation of the valve arrangement 22, while the high-pressure connection 34 tapers to the second high-pressure connection region 68. At said location, the high-pressure port 34 advantageously has an external thread 74, onto which the high-pressure storage line 26 can be screwed to form the high-pressure region 25.

The bore intersection 64, via which the flow bore 62 is fluidly connected to the two receptacle bores 40, may be located in the region with the relatively large external diameter 70, specifically in the first high-pressure connection region 66. The flow bore 62 therefore extends from the second high-pressure connection region 68 into the first high-pressure connection region 66. In contrast, the two receptacle bores 40 are arranged exclusively in the first high-pressure connection region 66.

The two receptacle bores 40 may include stepped blind hole bores 58 and therefore both have a first bore region 76 with a first bore diameter 78 and a second bore region 80 with a second bore diameter 82. The second bore diameter 82 is smaller than the first bore diameter 78, such that a step 84 is produced in each receptacle bore 40.

Since in the described embodiment the valve arrangement 22 is embodied overall as a cartridge, the parts of the two valves 24, 38 are provided as individual parts which are attached individually in the receptacle bores 40. The steps 84 in the two receptacle bores 40 can therefore serve to support elements of these individual parts. For example, the restoring spring 44 of the outlet valve 24 in FIG. 2 is supported by its rear end on this step 84. The step 84 in the receptacle bore 40 for the pressure-limiting valve 38 serves to receive a valve seat sleeve 86, on which the pressure-limiting valve seat 50 is formed.

The second bore region 80 forms a blind hole end 88, on which the bore intersection 64 with the flow bore 62 is arranged. To be able to utilize the installation space in the high-pressure port 34 efficiently, the receptacle bores 40 may be arranged symmetrically about the longitudinal axis 52 of the valve housing, and the flow bore 62 is formed symmetrically about the longitudinal axis 52 of the valve housing.

During operation, the high-pressure port 34 is attached to a housing of the high-pressure fuel pump 18 in the region of the junction surface 54. At said location, the high-pressure port 34 accordingly has a first attachment region 90. In the region in which the high-pressure port 34 has the external thread 74, the high-pressure port 34 forms a second attachment region 92, to which the high-pressure storage line 26 can be screwed. Depending on the embodiment of the outlet valve 24 and of the pressure-limiting valve 38, the receptacle bores 40 can be configured differently, in particular in respect of their diameter.

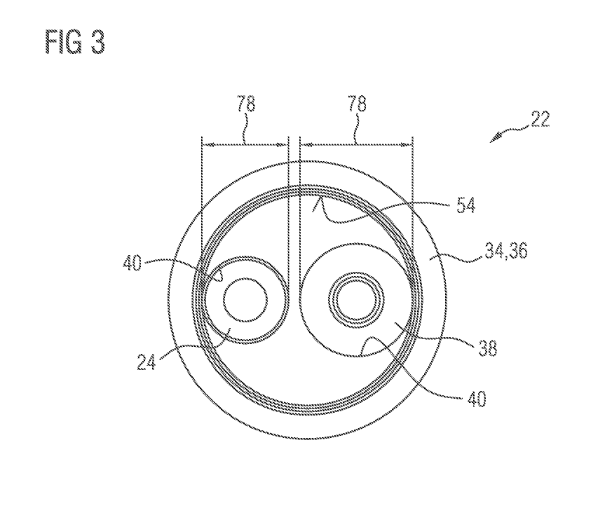

FIG. 3 shows a plan view of the high-pressure port 34 in FIG. 2 in the region of the junction surface 54, wherein it can be seen that the pressure-limiting valve 38 has a larger first bore diameter 78 than the receptacle bore 40 in which the outlet valve 24 is arranged.

However, it is also possible for the two valves 24, 38 to be configured in such a way that the receptacle bores 40 are completely identical, that is to say, not only with respect to their length and shape but also with respect to their overall diameters.

1. A fuel injection system for an internal combustion engine, the system comprising:
a high-pressure fuel pump with a pressure chamber housing a pump piston moving to pressurize a fuel;
a high-pressure region downstream of the high-pressure fuel pump into which the pump piston feeds the pressurized fuel; and
a valve arrangement connecting the pressure chamber to the high-pressure region;
wherein the valve arrangement includes an outlet valve with an outlet valve closing element preloaded against an outlet valve seat counter to a pressure force acting from the pressure chamber;
the valve arrangement includes a pressure-limiting valve with a pressure-limiting valve closing element preloaded against a pressure-limiting valve seat counter to a pressure force acting from the high-pressure region;
the outlet valve and the pressure-limiting valve are mounted in two separate receptacle bores in a common valve housing;
the two separate receptacle bores extend along a longitudinal axis of the valve housing from a junction surface at a first longitudinal end of the valve housing into the valve housing;
the valve housing defines a central flow bore at a second longitudinal end arranged opposite the first longitudinal end; and
the two separate receptacle bores are each fluidly connected to the central flow bore by a bore intersection.

2. The fuel injection system as claimed in claim 1, wherein the two separate receptacle bores each comprise a blind hole bore and extend parallel to one another and parallel to the longitudinal axis of the valve housing.

3. The fuel injection system as claimed in claim 2, wherein:
the two separate receptacle bores each have a first bore region with a first bore diameter and a second bore region with a second bore diameter;
the second bore diameter is smaller than the first bore diameter; and
in each case, the second bore region comprises a blind hole end.

4. The fuel injection system as claimed in claim 1, wherein:
the flow bore extends symmetrically about the longitudinal axis of the valve housing; and
the receptacle bores extend symmetrically about the longitudinal axis of the valve housing.

5. The fuel injection system as claimed in claim 1, wherein the valve housing comprises a high-pressure port for connecting a high-pressure storage line to a housing of the high-pressure fuel pump.

6. The fuel injection system as claimed in claim 5, wherein:
the high-pressure port comprises a first attachment region for attaching the high-pressure port to the housing of the high-pressure fuel pump and a second attachment region for connecting the high-pressure storage line to the high-pressure port; and
the first attachment region is formed at the first longitudinal end of the valve housing and the second attachment region is formed at the second longitudinal end of the valve housing.

7. The fuel injection system as claimed in claim 5, wherein:
the high-pressure port includes, along the longitudinal axis of the valve housing, a first high-pressure connection region with a first connection diameter and a second high-pressure connection region with a second connection diameter;
the second connection diameter is smaller than the first connection diameter; and
the receptacle bores are arranged exclusively in the first high-pressure connection region.

8. The fuel injection system as claimed in claim 7, wherein the flow bore is arranged in the second high-pressure connection region and extends from the second high-pressure connection region into the first high-pressure connection region.
